(19) United States
(12) Patent Application Publication
(10) Pub. No.: US 2025/0030742 A1
(43) Pub. Date: Jan. 23, 2025

(54) CLOUD COMPUTING CYBERSECURITY MATRIX WITH OVERLAID MATURITY MODEL

(71) Applicant: Wells Fargo Bank, N.A., San Francisco, CA (US)

(72) Inventors: Rachel Yun Kim Bierner, Los Angeles, CA (US); Adrian Lane, Phoenix, AZ (US); Alina LeClair, Austin, TX (US); Molly Morgan, Bermuda Run, NC (US); David Mortman, Worthington, OH (US); Tracie Wescott, Charlotte, NC (US)

(21) Appl. No.: 18/356,299

(22) Filed: Jul. 21, 2023

(51) Int. Cl. H04L 9/40

(52) U.S. Cl. CPC H04L 63/20

(57) ABSTRACT

An example computer system for providing a maturity model can include: one or more processors; and non-transitory computer-readable storage media encoding instructions which, when executed by the one or more processors, causes the computer system to: use a cloud computing cybersecurity matrix that organizes a suite of cybersecurity capabilities associated with a cloud computing environment; overlay the maturity model onto the cloud computing cybersecurity matrix, the maturity model measuring a maturity level of technologies associated with the cloud computing environment; and display a dashboard showing the cloud computing cybersecurity matrix with the maturity model overlaid thereon.

### BACKGROUND

A cyber defense matrix exists to allow cybersecurity practitioners to organize and understand a suite of possible cybersecurity capabilities. However, this matrix is designed for traditional on-premise computing environments and fails to address the needs of cloud computing environments. This can make it difficult to organize and categorize the cloud security protection ecosystem.

### SUMMARY

Examples provided herein are directed to cloud computing cybersecurity matrices and overlaid maturity models.

According to aspects of the present disclosure, an example computer system for providing a maturity model can include: one or more processors; and non-transitory computer-readable storage media encoding instructions which, when executed by the one or more processors, causes the computer system to: use a cloud computing cybersecurity matrix that organizes a suite of cybersecurity capabilities associated with a cloud computing environment; overlay the maturity model onto the cloud computing cybersecurity matrix, the maturity model measuring a maturity level of cloud security capabilities and enabling technologies associated with the cloud computing environment; and display a dashboard showing the cloud computing cybersecurity matrix with the maturity model overlaid thereon.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for providing a cloud computing cybersecurity matrix and overlaid maturity model.

FIG. 2 shows example logical components of a modeling device of the system of FIG. 1.

FIG. 3 shows an example cloud computing cybersecurity matrix generated by the modeling device of FIG. 2.

FIG. 4 shows an example maturity model generated by the modeling device of FIG. 2.

FIG. 5 shows an example dashboard generated by the modeling device of FIG. 2.

FIG. 6 shows an example method for generating a cloud computing cybersecurity matrix and overlaid maturity model.

FIG. 7 shows example physical components of the modeling device of FIG. 2.

### DETAILED DESCRIPTION

This disclosure relates to cloud computing cybersecurity matrices and overlaid maturity models. In the examples provided herein, the cloud computing cybersecurity matrices and overlaid maturity models are applicable to cloud computing environments.

An example cloud computing cybersecurity matrix can examine a variety of security functions, such as: Identify, Protect, Detect, Respond, and Recover. The cloud computing cybersecurity matrix can be used to: (i) consistently map, describe, and organize cloud security capabilities and solutions; (ii) ensure comprehensive and layered protection across the technology stack and security functions; (iii) simplify capability review and analysis; (iv) uncover capability gaps and areas where additional enhancements or controls may be needed; and (v) identify opportunities to consolidate or divest where capabilities or solutions are oversaturated.

In addition, examples can provide a maturity overlay to the cloud computing cybersecurity matrix, which describes the efficacy of cloud security capabilities in a gradient fashion, partitioning larger problems into smaller problems to help prioritize and focus cybersecurity risk mitigation efforts.

The example cloud computing cybersecurity matrices and overlaid maturity models can provide a standardized approach to assess current cloud security capabilities and design and plan for the advancement of capabilities and the cloud cybersecurity program at large over time. The maturity models can leverage three maturity tiers:
(i) Traditional: Capabilities leverage manual processes with minimal integration; security policies are static; limited visibility;
(ii) Advanced: Capabilities leverage some automation and integration of processes; conditional policies are codified, where possible; centralized visibility; and
(iii) Optimal: Capabilities with fully automated processes, conditional and dynamic policy enforcement; comprehensive visibility with advanced analytics leveraging artificial intelligence and/or machine learning.

The cloud computing cybersecurity matrices and overlaid maturity models can be used in a security environment to help articulate where an enterprise stands with respect to cloud security capabilities. The models also allow for a deeper dive into specific areas to identify potential gaps and guide execution to achieve desired maturity levels. Finally, the models assist in communication of the efficacy of the security programs.

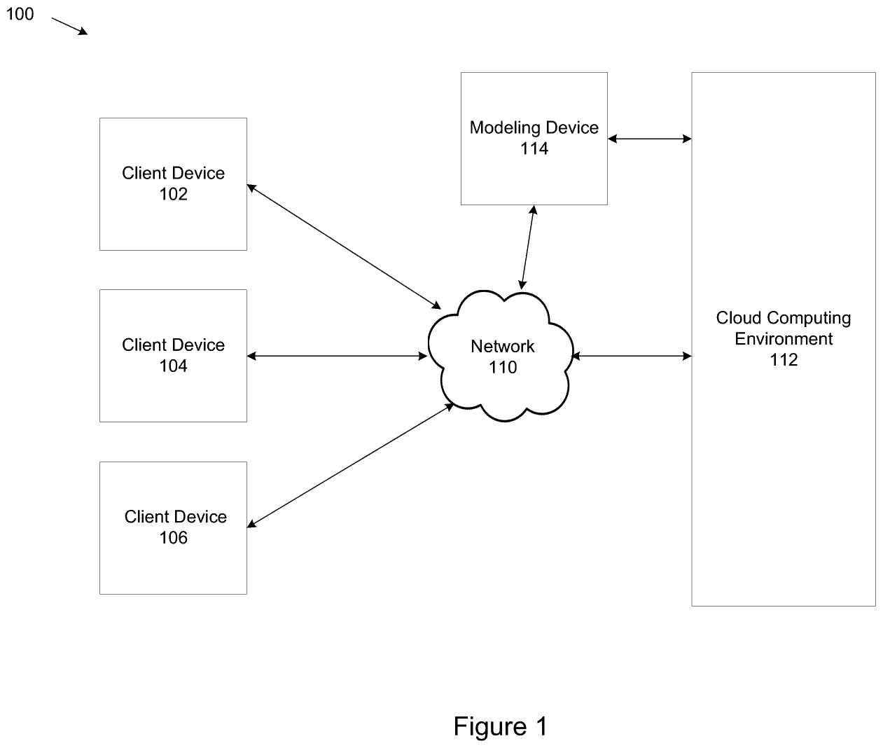

FIG. 1 schematically shows aspects of one example system 100 for an enterprise. The enterprise can be any type of business. In one non-limiting example, the enterprise is a financial institution that provides financial services to customers. However, the concepts described herein are equally applicable to other types of entities.

Generally, the system 100 can be a typical computing environment that includes a plurality of client devices 102, 104, 106 and a cloud computing environment 112. The client devices 102, 104, 106 communicate with the cloud computing environment 112 to accomplish business tasks.

Each of the client devices 102, 104, 106 and the cloud computing environment 112 may be implemented as one or more computing devices with at least one processor and memory. Example computing devices include a mobile computer, a desktop computer, a server computer, or other computing device or devices such as a server farm or cloud computing used to generate or receive data.

In the examples shown, the client devices 102, 104, 106 can be used by customers or employees of the business to conduct business. For instance, the client devices 102, 104, 106 can communicate with the cloud computing environment 112 through a network 110.

The cloud computing environment 112 can be programmed to deliver functionality to the client devices 102, 104, 106. For example, in one embodiment, the cloud computing environment 112 is formed by one or more computers (typically a server farm or part of a cloud computing environment) that facilitates the various business processes of the enterprise.

More specifically, the cloud computing environment 112 is a cloud server that provides cloud computing resources (storage, databases, processing, etc.) to the client devices 102, 104, 106 over the network 110, such as the Internet. This is in contrast to an on-premise computing environment, where such resources would be provided locally.

As depicted, the system 100 also includes a modeling device 114 that communicates with the cloud computing environment 112. The modeling device 114 is programmed to develop a cloud computing cybersecurity matrix and maturity model for the cloud computing environment 112. This process is described below.

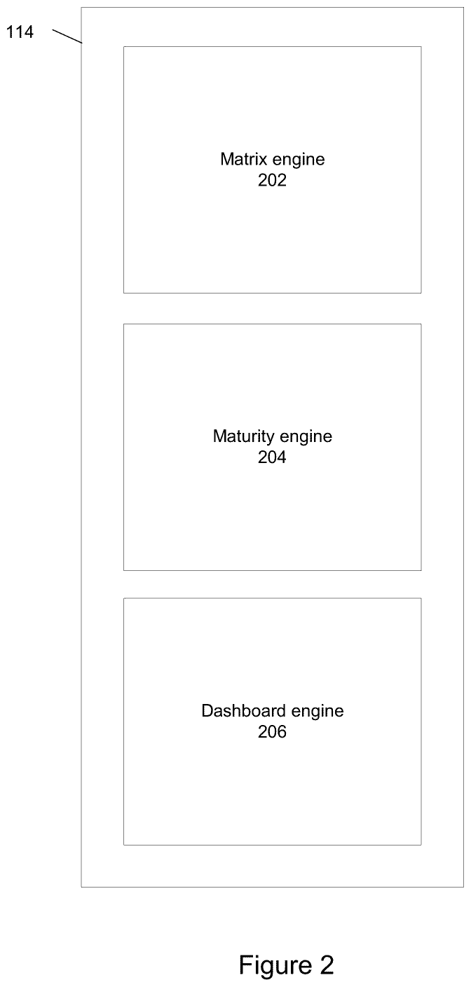

Referring now to FIG. 2, additional details on the modeling device 114 are provided. In the examples provided herein, the modeling device 114 is programmed to develop the cloud computing cybersecurity matrix and maturity model, which can be used as a standardized approach to assess current cloud security capabilities of the cloud computing environment 112 and design and plan for the advancement of capabilities over time.

In example embodiments, the example modeling device 114 includes a matrix engine 202, a maturity engine 204, and a dashboard engine 206. Together, these components are programmed to generate the cloud computing cybersecurity matrix and overlaid maturity model, as described below.

The example matrix engine 202 of the modeling device 114 is programmed to generate a cloud computing cybersecurity matrix that organizes the suite of cybersecurity capabilities associated with the cloud computing environment 112. In this example, the cloud computing cybersecurity matrix mirrors the industry cybersecurity framework provided by the National Institute of Standards and Technology of Gaithersburg, Maryland. However, in contrast to the cybersecurity framework provided by NIST, the matrix engine 202 is tailored for the cloud computing environment.

In this example, the cloud computing cybersecurity matrix defined by the matrix engine 202 is configured to:
consistently map, describe, and organize cloud security capabilities and solutions;
ensure comprehensive and layered protection across the technology stack and security functions;
simplify capability review and analysis;
uncover capability gaps and areas where additional enhancements or controls may be needed; and/or
identify opportunities to consolidate or divest where capabilities or solutions are oversaturated.

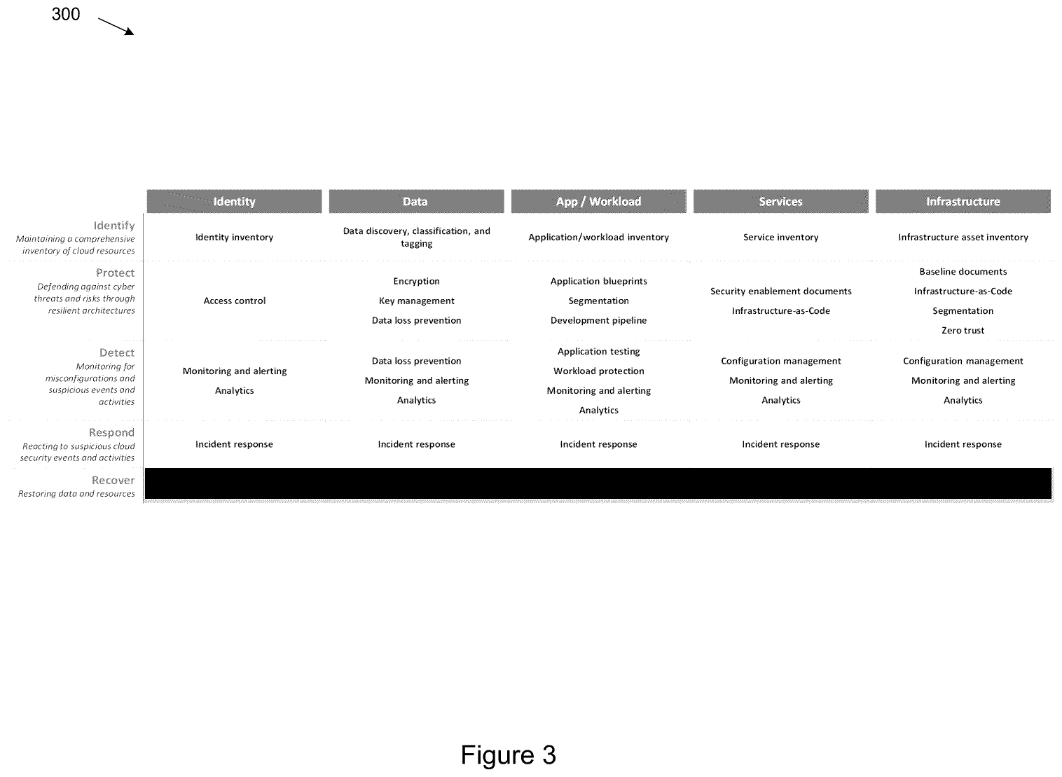

For instance, referring now to FIG. 3, an example cloud computing cybersecurity matrix 300 is shown for the cloud computing environment 112 as generated by the matrix engine 202. In this example, the cloud computing cybersecurity matrix 300 examines various technology tiers specific to the cloud computing environment, as follows.

| Technology | |
|---|---|
| Tier | Resource Examples |
| Identity | User IDs, authentication tokens, access keys, |
| | machine/service identities |
| Data | Contact information, account numbers, IP addresses |
| Application/ | Custom developed or commercially available computer |
| Workload | programs; containers |
| Services | Azure Key Vault, Google Key Management |
| | Service, Azure Kubernetes Service, |
| | Google Kubernetes Engine, Azure |
| | Storage, Azure SQL MI |
| Infrastructure | Virtual networks, security groups, Domain Name System |
| | (DNS), Dynamic Host Configuration Protocol (DHCP), |
| | network interfaces, network gateways, virtual network |
| | peering |

The matrix engine 202 is programmed to apply the five security functions (Identify, Protect, Detect, Respond, and Recover) for each technology tier associated with the cloud computing environment 112.

For instance, for the “Identity” technology tier, the matrix engine 202 is programmed to apply the five security functions to the cloud computing environment 112. For the Identify security function, the matrix engine 202 is programmed to catalogue the cloud security capabilities associated therewith for the cloud computing environment 112, such as providing attributes associated with an identity inventory. Similarly, for the Protect security function, the matrix engine 202 is programmed to catalogue attributes associated with access control. Many configurations are possible.

Referring back to FIG. 2, the example maturity engine 204 is programmed to apply a maturity overlay to the cloud computing cybersecurity matrix 300 that is generated by the matrix engine 202. In this example, the maturity engine 204 uses a maturity scale of three levels of maturity. This example maturity scale can be based upon the Department of Homeland Security (DHS) Cybersecurity and Infrastructure Security Agency's (CISA) Zero Trust maturity model. The three maturity tiers form a gradient from low (traditional) to high (optimal) as follows:
Traditional: capabilities leverage manual processes with minimal integration; security policies are static; limited visibility;
Advanced: capabilities leverage some automation and integration of processes; conditional policies are codified, where possible; centralized visibility; and
Optimal: capabilities with fully automated processes, conditional and dynamic policy enforcement; comprehensive visibility with advanced analytics leveraging artificial intelligence/machine learning.

For example, to streamline and drive objectivity of the assessments, the three levels of maturity are applied to the foundational cloud security characteristics that are inherent to each of the five security functions and the respective technology tiers.

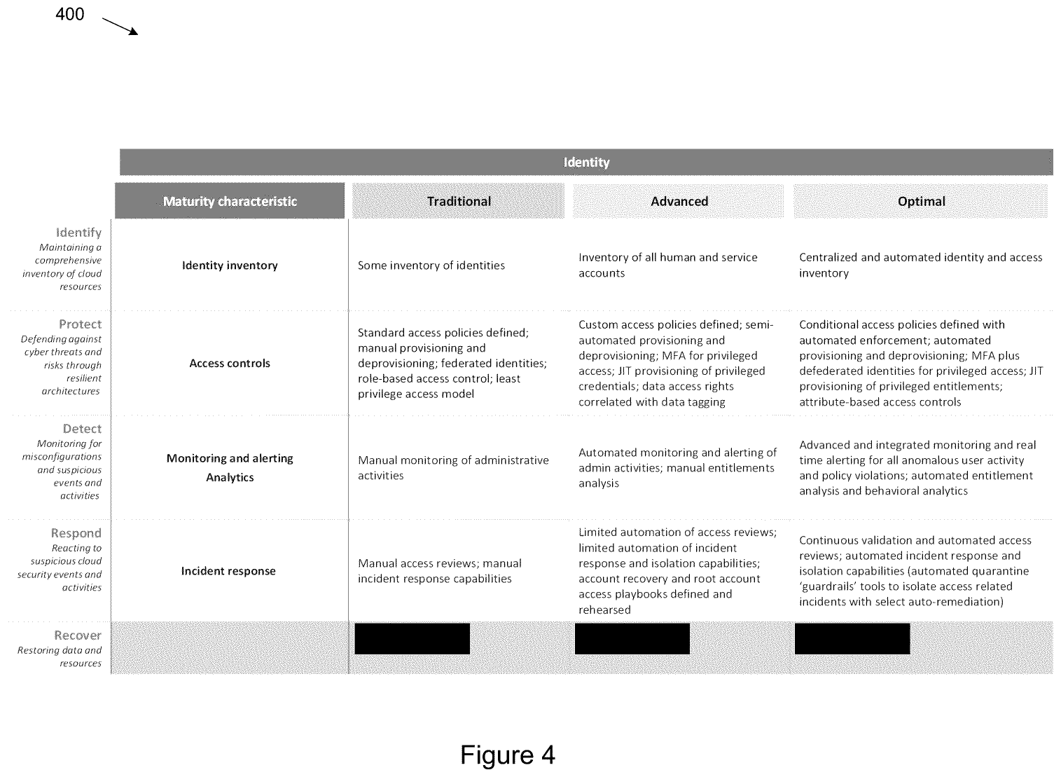

This is illustrated in a maturity model 400 developed by the maturity engine 204 shown in FIG. 4. For example, “access control” broadly represents the Protect function for the Identity technology tier (see FIG. 3). Further, access controls can be translated by the maturity engine 204 into specific capabilities for each maturity stage, following the maturity level definitions above.

In some examples, the maturity level is defined by comparing the current state of maturity of the technology tiers for the enterprise to various metrics. For instance, benchmarks can be set based upon the industry, competitors and/or priority/risk associated with each technology. These benchmarks can be used to rate the current level of maturity and define target levels of maturity.

For the access control example, each of the three maturity tiers is defined in the model 400. The maturity gradient from lowest access controls (traditional) to highest access controls (optimal) is thereby defined by the model 400.

Referring back to FIG. 2, the example dashboard engine 206 is programmed to display aspects of the model 400. For instance, the dashboard engine 206 can display the cloud computing cybersecurity matrix and maturity overlay, along with aspects associated with remediation of any gaps identified by the model 400. This particular arrangement of components results in the practical application of a more efficient manner in which to display the noted information.

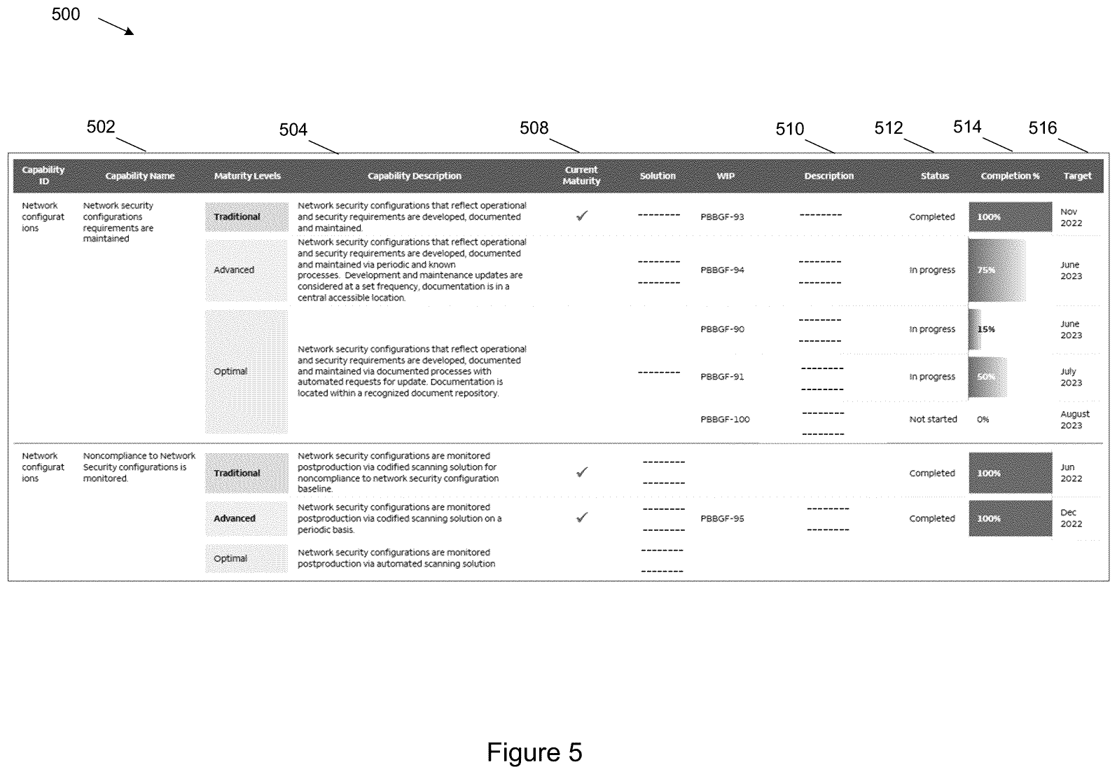

For example, referring to FIG. 5, an example dashboard 500 as created by the dashboard engine 206 is shown. In this embodiment, the dashboard 500 displays particular aspects of the cloud computing cybersecurity matrix and associated maturity overlay relating to network configurations. The dashboard 500 can be visualized in many different manners, such as by using the Tableau visual analytics platform from Tableau Software, LLC.

Generally, the dashboard 500 can be configured to display different states of the enterprise. For instance, the dashboard 500 can be confirmed to allow for selection of a current state of the cloud computing environment and a desired target state of the cloud computing environment associated with the enterprise. The dashboard 500 can be programmed to obtain or receive an automated feed of current prioritizations and capabilities for the cloud computing. As provided below, coding can be used to indicate current states of the technologies, such as color, bars, etc.

In this example, the dashboard 500 includes a capability name field 502 that identifies the respective capability, such as network security configurations. The dashboard 500 also includes a maturity description field 504 that identifies the three maturity levels and provides a description of the capabilities for each. A current maturity field 508 identifies the current level of maturity for the particular capability. In the example, a check mark is provided for each level of maturity achieved. In the sample, the network security configurations capability is currently at the traditional (or lowest) maturity level.

The dashboard 500 also includes a description field 510 that describes the work that is being done to maintain or elevate the maturity level of each capability. For instance, in the network security configurations capability, Service Enablement Documents (SEDs) are being updated to improve the maturity level. A status field 512 provides a status of the work (e.g., Not yet started. In progress. Completed), and a completion percentage field 514 indicates a percentage (e.g., 0%, 75%, 100%) of the work. Finally, a target completion field 516 defines when the work is scheduled to be completed (e.g., November 2022). Many other configurations are possible.

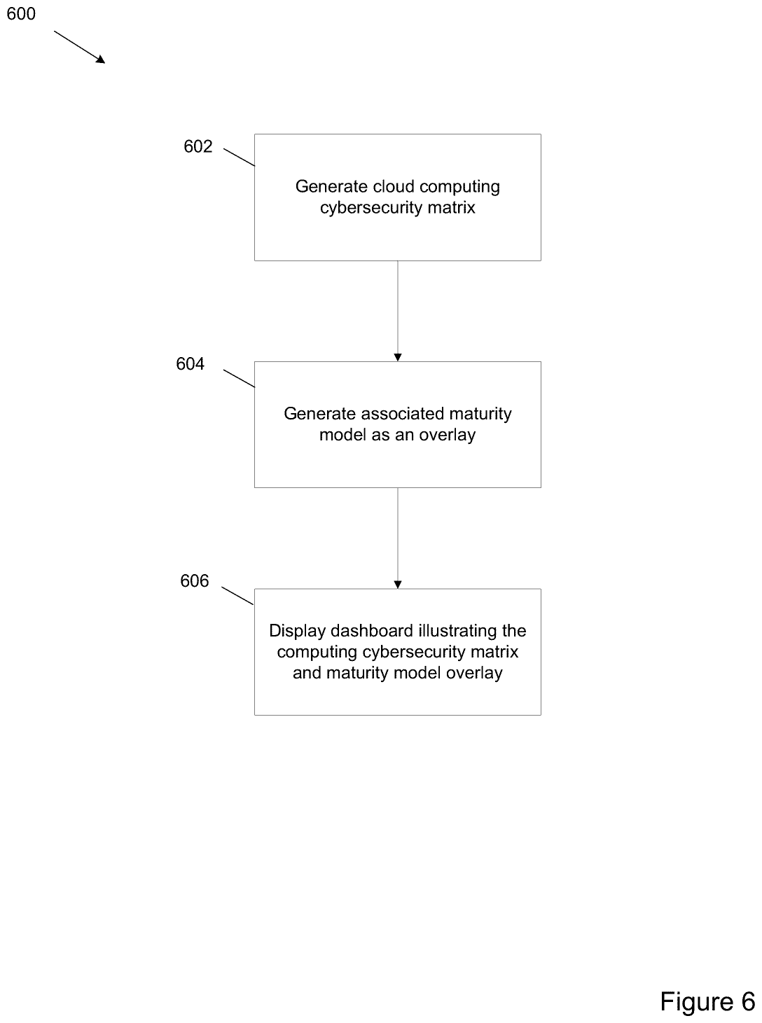

Referring now to FIG. 6, an example method 600 is provided for generating and displaying the cloud computing cybersecurity matrix and associated maturity model overlay by the modeling device 114.

At operation 602, the cloud computing cybersecurity matrix is generated by accessing aspects of the cloud computing environment utilized by the enterprise. Next, at operation 604, the maturity model is developed as an overlay of the cloud computing cybersecurity matrix. Finally, at operation 606, a dashboard is displayed to provide details of the maturity model.

There can be various advantages associated with the creation and display of the cloud computing cybersecurity matrix and maturity models. For instance, the creation of the models can assist in the consistent definition and display of a current state of the enterprise with respect to cybersecurity for cloud computing and the maturity thereof. The models can also allow for a deeper exploration into various security topics (e.g., Zero Trust) and specific domains (e.g., IAM) to better understand the cloud computing security capabilities within each area and identify any potential gaps for the enterprise. Further, the models can drive creation of corresponding roadmaps to address identified gaps and guide execution efforts to achieve desired maturity levels. Many other advantages are possible.

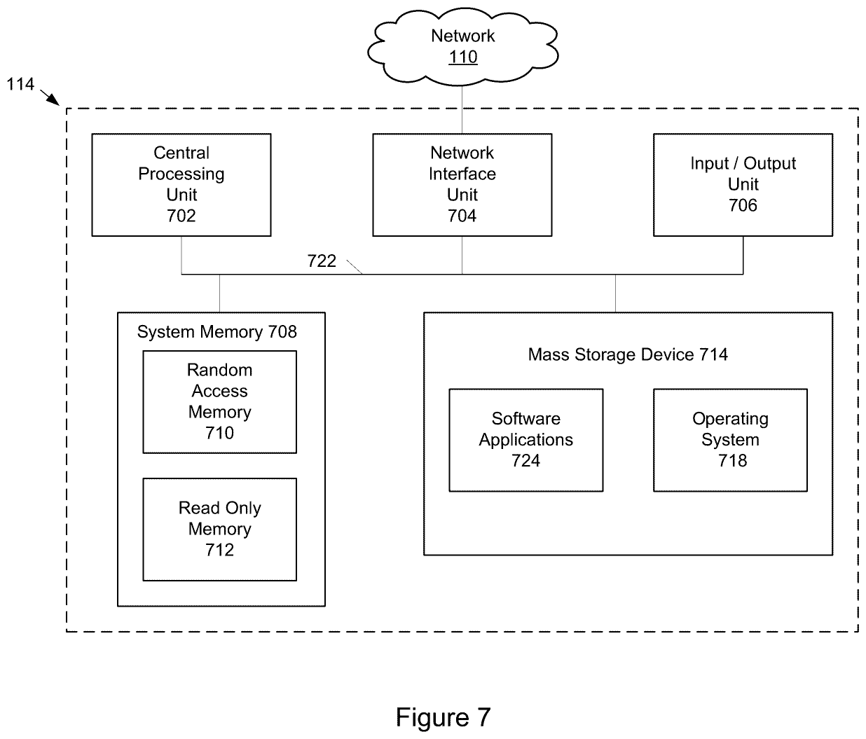

As illustrated in the embodiment of FIG. 7, the example modeling device 114 which provides the modeling can include at least one central processing unit (“CPU”) 702, a system memory 708, and a system bus 722 that couples the system memory 708 to the CPU 702. The system memory 708 includes a random access memory (“RAM”) 710 and a read-only memory (“ROM”) 712. A basic input/output system containing the basic routines that help transfer information between elements within the modeling device 114, such as during startup, is stored in the ROM 712. The modeling device 114 further includes a mass storage device 714. The mass storage device 714 can store software instructions and data. A central processing unit, system memory, and mass storage device similar to that in FIG. 7 are also included in other computing devices disclosed herein (e.g., the devices 102, 104, 106, 112).

The mass storage device 714 is connected to the CPU 702 through a mass storage controller (not shown) connected to the system bus 722. The mass storage device 714 and its associated computer-readable data storage media provide non-volatile, non-transitory storage for the modeling device 114. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the modeling device 114.

According to various embodiments of the invention, the modeling device 114 may operate in a networked environment using logical connections to remote network devices through network 110, such as a wireless network, the Internet, or another type of network. The modeling device 114 may connect to network 110 through a network interface unit 704 connected to the system bus 722. It should be appreciated that the network interface unit 704 may also be utilized to connect to other types of networks and remote computing systems. The modeling device 114 also includes an input/output controller 706 for receiving and processing input from a number of other devices, including a touch user interface display screen or another type of input device. Similarly, the input/output controller 706 may provide output to a touch user interface display screen or other output devices.

As mentioned briefly above, the mass storage device 714 and the RAM 710 of the modeling device 114 can store software instructions and data. The software instructions include an operating system 718 suitable for controlling the operation of the modeling device 114. The mass storage device 714 and/or the RAM 710 also store software instructions and applications 724, that when executed by the CPU 702, cause the modeling device 114 to provide the functionality of the modeling device 114 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A computer system for providing a maturity model, comprising:
one or more processors; and
non-transitory computer-readable storage media encoding instructions which, when executed by the one or more processors, causes the computer system to:
use a cloud computing cybersecurity matrix that organizes a suite of cybersecurity capabilities associated with a cloud computing environment; and
overlay the maturity model onto the cloud computing cybersecurity matrix, the maturity model measuring a maturity level of cloud security capabilities and enabling technologies associated with the cloud computing environment.

2. The computer system of claim 1, wherein the cloud computing cybersecurity matrix includes technology tiers specific to the cloud computing environment.

3. The computer system of claim 2, wherein the technology tiers include one or more of: identity; data; applications and workloads; services; and infrastructure.

4. The computer system of claim 1, wherein the maturity level includes a maturity scale to rate each of the cloud security capabilities and enabling technologies associated with the cloud computing environment.

5. The computer system of claim 4, wherein the maturity scale has maturity tiers including: traditional, with capabilities leveraging manual processes with minimal integration, static security, and limited visibility; advanced, with capabilities leveraging some automation and integration of processes, conditional policies, and centralized visibility; and optimal, with fully automated processes, conditional and dynamic policies, and comprehensive visibility.

6. The computer system of claim 1, comprising further instructions which, when executed by the one or more processors, causes the computer system to display a dashboard showing the cloud computing cybersecurity matrix with the maturity model overlaid thereon.

7. The computer system of claim 6, wherein the dashboard further includes: a current maturity; and a percentage completion for each maturity level.

8. The computer system of claim 6, wherein the dashboard is configured to receive an automated feed of current prioritizations and capabilities for the cloud computing environment.

9. The computer system of claim 1, comprising further instructions which, when executed by the one or more processors, causes the computer system to use one or more benchmarks to rate the maturity level of the cloud security capabilities and enabling technologies associated with the cloud computing environment.

10. The computer system of claim 9, wherein the one or more benchmarks are based upon one or more of: industry standards; competitor standard; and priorities and risks.

11. A method for providing a maturity model, comprising:
using a cloud computing cybersecurity matrix that organizes a suite of cybersecurity capabilities associated with a cloud computing environment;
overlaying the maturity model onto the cloud computing cybersecurity matrix, the maturity model measuring a maturity level of cloud security capabilities and enabling technologies associated with the cloud computing environment; and
displaying a dashboard showing the cloud computing cybersecurity matrix with the maturity model overlaid thereon.

12. The method of claim 11, wherein the cloud computing cybersecurity matrix includes technology tiers specific to the cloud computing environment.

13. The method of claim 12, wherein the technology tiers include one or more of: identity; data; applications and workloads; services; and infrastructure.

14. The method of claim 11, wherein the maturity level includes a maturity scale to rate each of the cloud security capabilities and enabling technologies associated with the cloud computing environment.

15. The method of claim 14, wherein the maturity scale has maturity tiers including: traditional, with capabilities leveraging manual processes with minimal integration, static security, and limited visibility; advanced, with capabilities leveraging some automation and integration of processes, conditional policies, and centralized visibility; and optimal, with fully automated processes, conditional and dynamic policies, and comprehensive visibility.

16. The method of claim 11, wherein the dashboard further includes the maturity level that is provided for the technology tiers.

17. The method of claim 16, wherein the dashboard further includes: a current maturity; and a percentage completion for each maturity level.

18. The method of claim 11, wherein the dashboard is configured to receive an automated feed of current prioritizations and capabilities for the cloud computing environment.

19. The method of claim 11, further comprising using one or more benchmarks to rate the maturity level of the cloud security capabilities and enabling technologies associated with the cloud computing environment.

20. The method of claim 19, wherein the one or more benchmarks are based upon one or more of: industry standards; competitor standard; and priorities and risks.
